(19) United States
(12) Patent Application Publication
(10) Pub. No.: US 2014/0001195 A1
(43) Pub. Date: Jan. 2, 2014

(54) CUP SINGULATION AND DENESTING MECHANISM

(71) Applicant: Manitowoc Foodservice Companies, LLC., Manitowoc, WI (US)

(72) Inventors: Nicholas PATTERSON, Odessa, FL (US); Kenneth LUNDBERG, Mt. Pleasant, MI (US)

(73) Assignee: Manitowoc Foodservice Companies, LLC, Manitowoc, WI (US)

(21) Appl. No.: 13/929,421

(22) Filed: Jun. 27, 2013

Related U.S. Application Data
(60) Provisional application No. 61/665,269, filed on Jun. 27, 2012.

(51) Int. Cl. B65G 59/10

(52) U.S. Cl. CPC B65G 59/106
USPC 221/1; 221/120; 221/13

(57) ABSTRACT

The cup singulation device of the present disclosure is an automated device, thus eliminating problems associated with users not able to extract single cups at a time, or destroying product by using too much force when doing so. A controller controls a cup holding table to present stacks of cups to an gripping device that grips and removes a single cup. A latch mechanism on the cup holder can hold the remainder of the stack in place to make sure that only one cup is removed.

### CROSS-REFERENCE TO RELATED APPLICATION

The present disclosure claims the benefit and priority of U.S. Provisional Application No. 61/665,269, filed on Jun. 27, 2012, which is herein incorporated by reference.

### BACKGROUND OF THE DISCLOSURE

1. Field of the Disclosure

The present disclosure generally relates to positive cup separation devices and methods that allows for consistent dispensing of a single cup at a time.

2. Discussion of the Background Art

Today stacks of cups are separated by multiple common methods. A flexible diaphragm is commonly used on fountain drink machines as means to separate one drinking cup from the next. (See, e.g., U.S. Pat. No. 6,102,246, especially FIG. 17B, cup restrainer members 230.) The diaphragm is typically comprised of flexible fingers or a flexible rubber like material with a central hole through which cups are pulled. This low cost solution provides generally good results but results in multiple cups being undesirably pulled upon occasion or the crushing of cups due to the force required to remove the cup from the dispensing cylinder or vessel. A different method, used in industrial settings, includes a slide mechanism that ejects the lowest cup in a stack and a cooperating pneumatic suction cup controls the dispensed cup. This method requires significant capital investment in pneumatics and robotics. It also requires clean, dry surfaces in a controlled environment to work properly. High speed automated fill lines utilize a plurality of worm gears or acme screws to dispense hundreds of cups per minute onto an assembly line where they are later aligned for filling.

Typically, gripper would pull cup through a diaphragm posing the difficult issue of how much grip force to use. Too much grip force raises the likelihood that two cups will be pulled from the bottom of the stack while to little force increases the likelihood that the gripper will slide off without gripping a cup.

The problem sought to be overcome is a consistent method of dispensing a single cup from a stack in an automated fashion. The present disclosure singulates cups consistently using automated processes and overcomes the aforementioned disadvantages of the prior art.

The present disclosure also provides many additional advantages, which shall become apparent as described below.

### SUMMARY OF THE DISCLOSURE

A cup singulation assembly comprising a plurality of interchangeable cup singulation wedge mechanisms of varying sizes assembled together into a circular configuration. The cup singulation wedge mechanisms can be either a single slide configuration, a dual slide configuration or a clamping lever configuration.

Further objects, features and advantages of the present disclosure will be understood by reference to the following drawings and detailed description.

Thus, in one embodiment, the present disclosure provides a cup dispensing apparatus. The apparatus comprises a cup holder for holding a plurality of the cups in stacked alignment, wherein said cup holder comprises a top surface, a bottom surface, and a plurality of holes therethrough. The apparatus also comprises gripping mechanism for removing a single, bottommost one of the cups from the cup holder at a time, wherein the gripping mechanism is slidably connected to a linear actuator. A controller is in communication with the cup holder and the gripping mechanism. The controller has a program resident thereon that controls the cup holder to present the cups to the gripping mechanism, and controls the gripping mechanism to grip one of the cups and remove it from the cup holder.

The present disclosure also provides a method of dispensing a cup from a cup holder, comprising: presenting a plurality of cups to a gripping device, wherein the plurality of cups are arranged in a stacked vertical alignment; controlling the gripping device to grip a bottommost one of said cups; retaining the remainder of said plurality of the stacked cups in place; and controlling the gripping device to remove the bottommost cup.

### BRIEF DESCRIPTION OF THE DRAWINGS

FIG. 1 is a bottom right-side perspective view of an automated beverage system incorporating the cup singulation and denesting mechanism according to the present disclosure;

FIG. 2 is a top left-side perspective view of the automated beverage system incorporating the cup singulation and denesting mechanism according to the present disclosure;

FIGS. 3a-b are bottom and top planar view of cup singulation assembly according to the present disclosure, respectively, comprising a plurality of interchangeable cup singulation wedge mechanisms of varying sizes assembled together into a circular configuration;

FIG. 4a is a top front perspective views of the cup singulation assembly of FIGS. 3a-b with cups handing therefrom and cylinder cup containers above;

FIG. 4b is a front planar perspective view of FIG. 4a depicting the cup holding mechanism of the cup singulation wedge mechanisms;

FIGS. 5a-g are schematic representations of the actuation of the slider cup singulation wedge mechanism embodiment according to the present disclosure;

FIGS. 6a-b are schematic representations of the actuation of the scissor clamping (levers) singulation wedge mechanism embodiment according to the present disclosure; and

FIGS. 7a-e are a schematic representations of the actuation of a dual slider singulation wedge mechanism according to yet another embodiment of the present disclosure.

### DETAILED DESCRIPTION OF THE DISCLOSURE

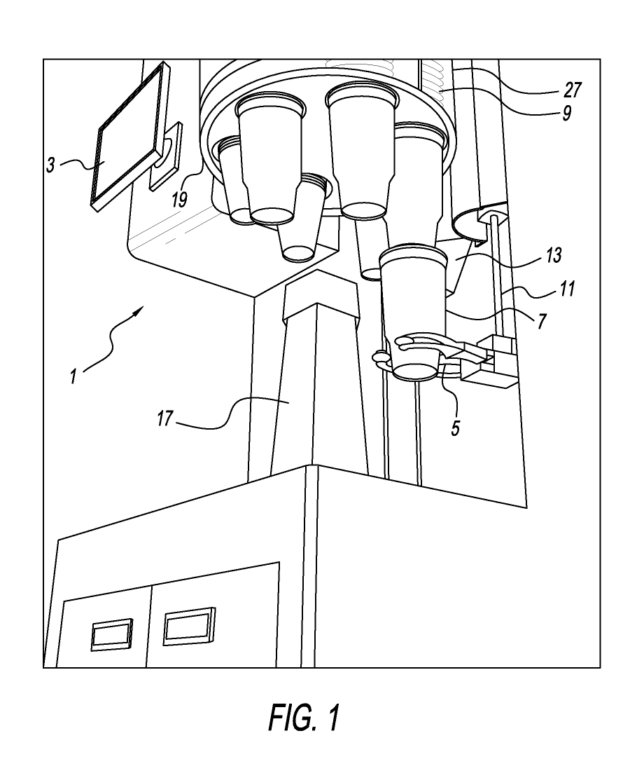

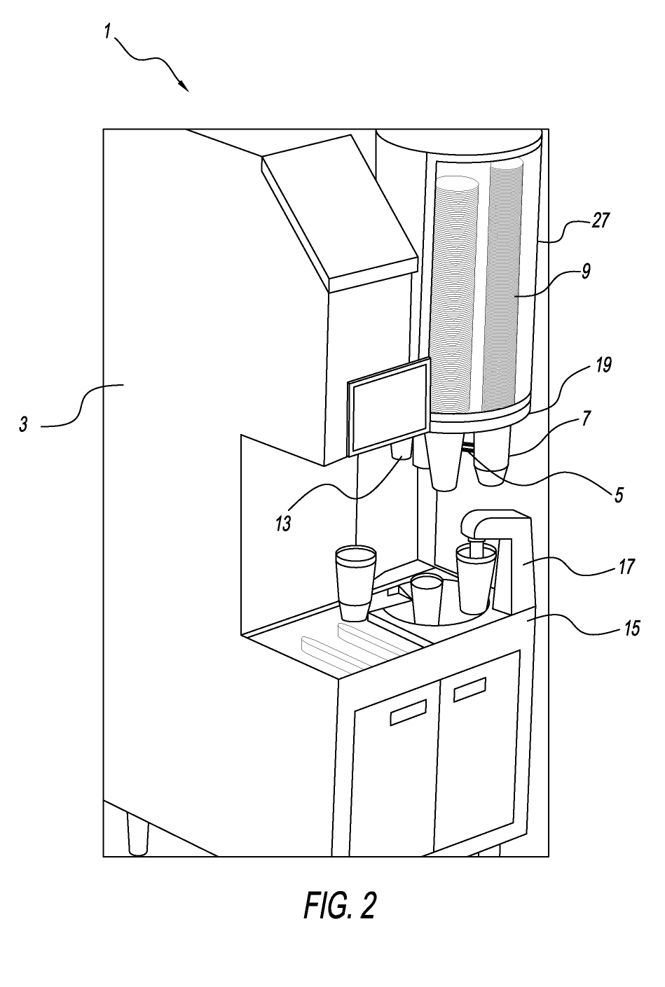

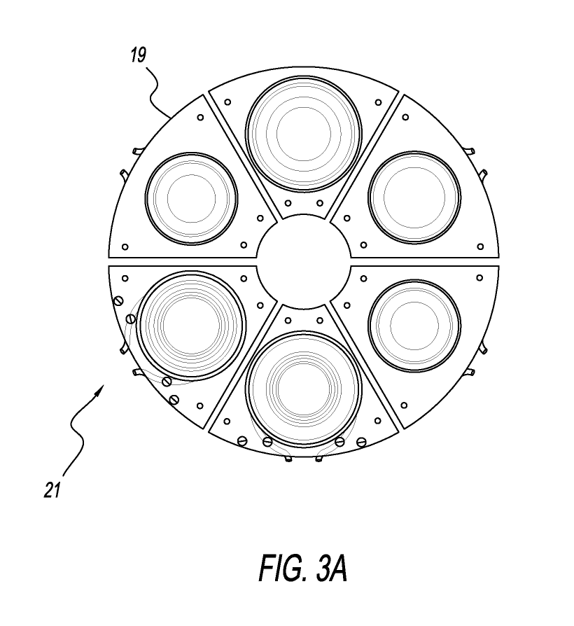

The present disclosure can be understood by reference to the figures, wherein FIGS. 1 and 2 depict an automated beverage system 1 having an interface display 3 for programming system 1. Alternatively, system 1 can receive orders from a point of sale (POS) system without direct input via display 3. Based upon the selections made on display 3, the controller (not shown) controls gripper 5 to grab a cup 7 of a preselected size from cup dispenser chamber 9. Gripper 5 is connected to a linear actuator 11 which is capable of moving in both the vertical up and down direction, as well as rotationally. Optionally, when cup 7 is secured by gripper 5 the linear actuator 11 will be lowered to display cup 7 from cup dispenser chamber 9. Once cup 7 is free of the other cups it can be either rotated and position under ice chute 13 such that ice can be dispensed therein pursuant to the preselected program entered into display 3. Thereafter, cup 7 with ice will be lowered by linear actuator 11 until it is received by cup management system 15 where it can be positioned under beverage dispenser 17 and filled with a preselected beverage pursuant to the preselected program entered into display 3.

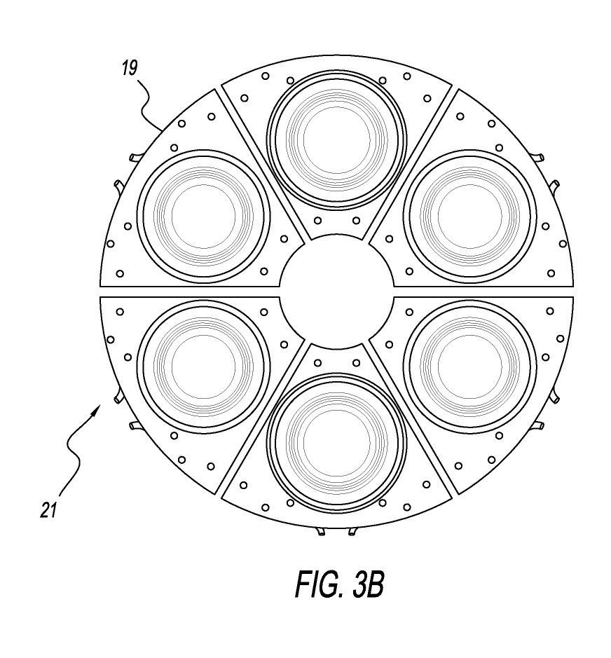

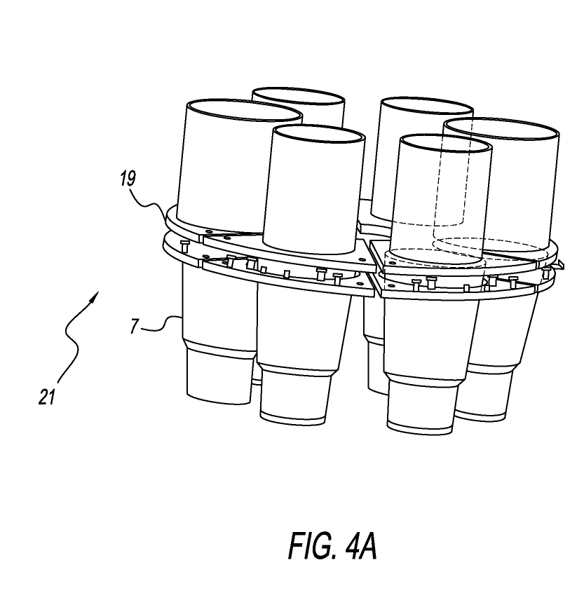

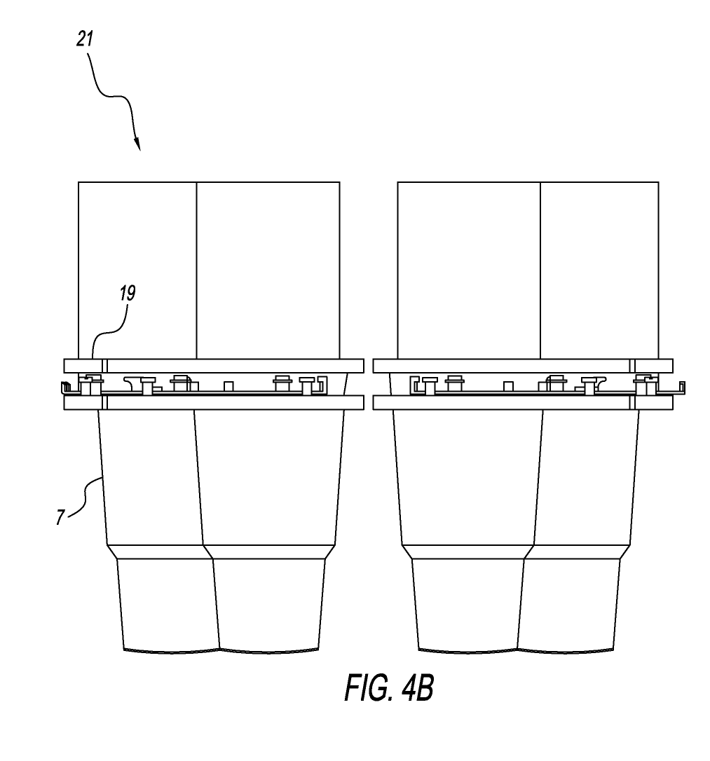

Cups 7 are held in interchangeable singulation wedge mechanisms 19, as shown in FIGS. 3a-b which show a plurality of wedge mechanisms 19 of differing sizes which form a wedge mechanism assembly 21. FIG. 4a is a top front perspective view of the cup singulation assembly of FIGS. 3a-b with cups protruding therefrom and cylinder cup containers above. FIG. 4b is a front planar perspective view of FIG. 4a depicting the cup holding mechanism of the cup singulation wedge mechanisms

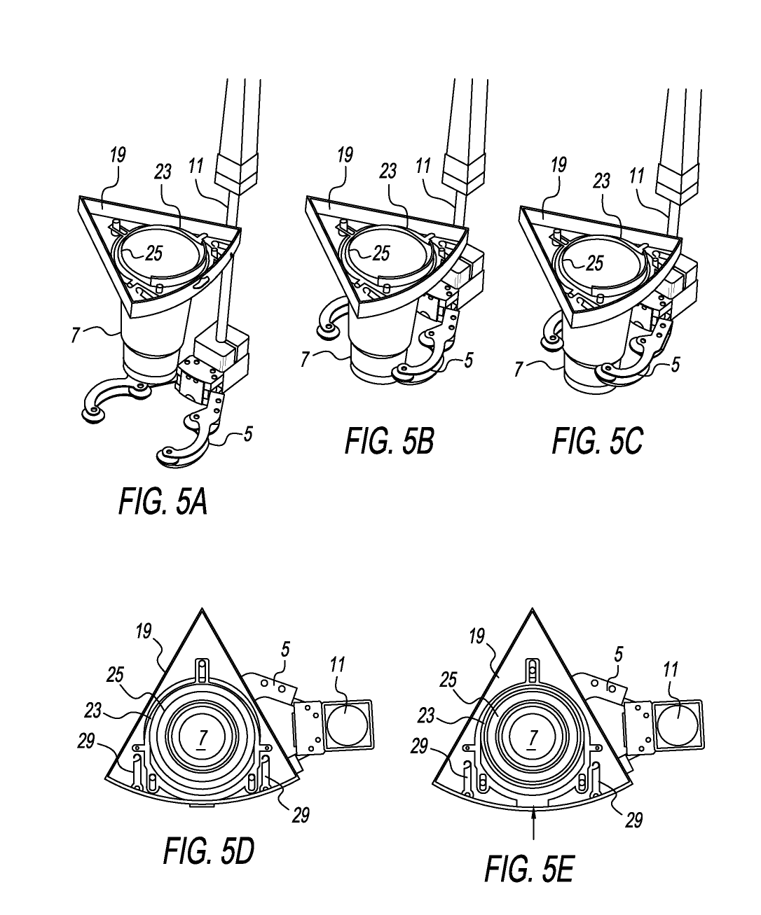

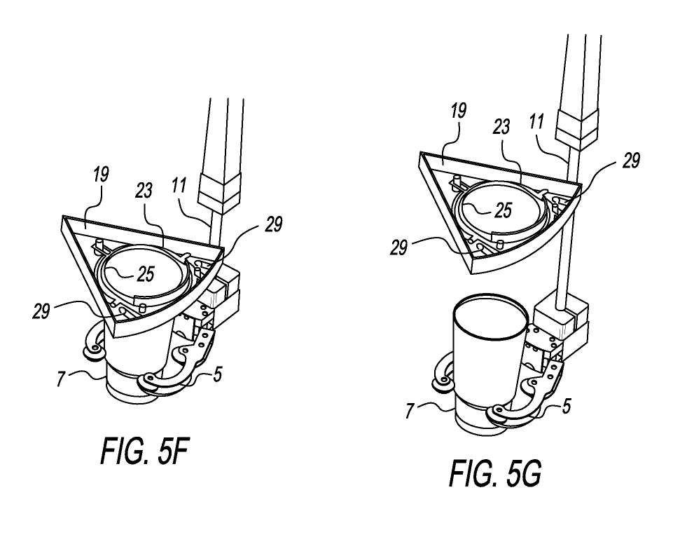

FIGS. 5a-g are schematic representations of the actuation of the slider cup singulation wedge mechanism embodiment according to the present disclosure, which utilizes a slide component 23 that engages under lip 25 of the bottom cup 7 in a stack 27. The removal procedure begins with a pneumatic gripper 5 rising to grab the bottom cup 7 on the stack 27. Gripper 5 is moved vertically by either a motorized linear slide or a linear actuator 11. When pneumatic gripper 5 reaches the desired vertical position on cup 7 a solenoid (not shown) is activated to close gripper 5 which holds bottom cup 7 in place. At this point slide component 23 is still engaged underneath lip 25 of bottom cup 7 in stack 27. After gripper 5 closes on cup 7 a solenoid is activated that moves slide component 23 horizontally out from under lip 25 of bottom cup 7. Gripper 5, now holding the entire stack of cups 27, is then moved down a specified amount equal to just over the thickness of cup lip 25. The distance gripper 5 travels is measured by either an encoder on linear actuator 11, a positioning sensor (not shown), or a step counter on a stepper motor (not shown). With cup stack 27 now moved down just more than the distance of one cup lip, the solenoid is de-activated allowing slide 23 to move back into the locked position under the 2nd from bottom cup in stack 27. The slide mechanism 23 is mounted with springs 29 that are extended when the solenoid is engaged and provides the force to pull slide 23 back into position under cup lip 25 when the solenoid is disengaged. With slide component 23 now locked under lip 25 of the second from bottom cup, gripper 5 is moved vertically downward pulling bottom cup 7 of stack 27 away. The major benefit of this slide locking mechanism is the low force required by gripper 5 to remove bottom cup 7. Slide lock mechanism 23 enables gripper 5 to squeeze cup 7 with any level of force and still pull just one cup every time. As shown in FIGS. 5d-e an actuator (not shown) is used to cause slide lock mechanism 23 to move in the locked position (FIG. 5d) to an unlocked position (FIG. 5e). Additional slide mechanisms are possible allowing for the same action.

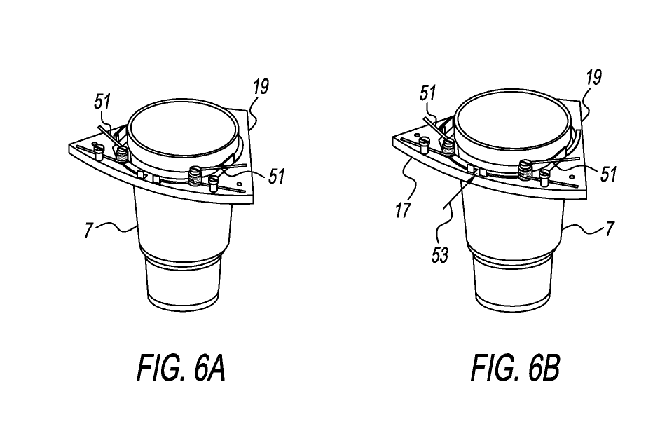

FIGS. 6a-b are schematic representations of the actuation of the scissor clamping (levers 51) singulation wedge mechanism embodiment according to the present disclosure. Similar to FIGS. 5d-e, levers 51 use an actuator shown by arrow 53 to move levers 51 from a locked to unlocked position.

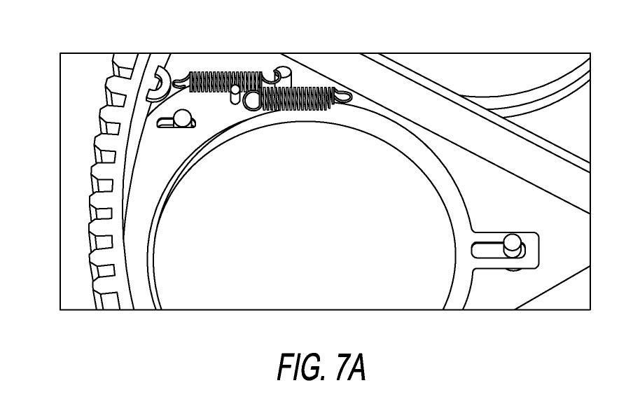

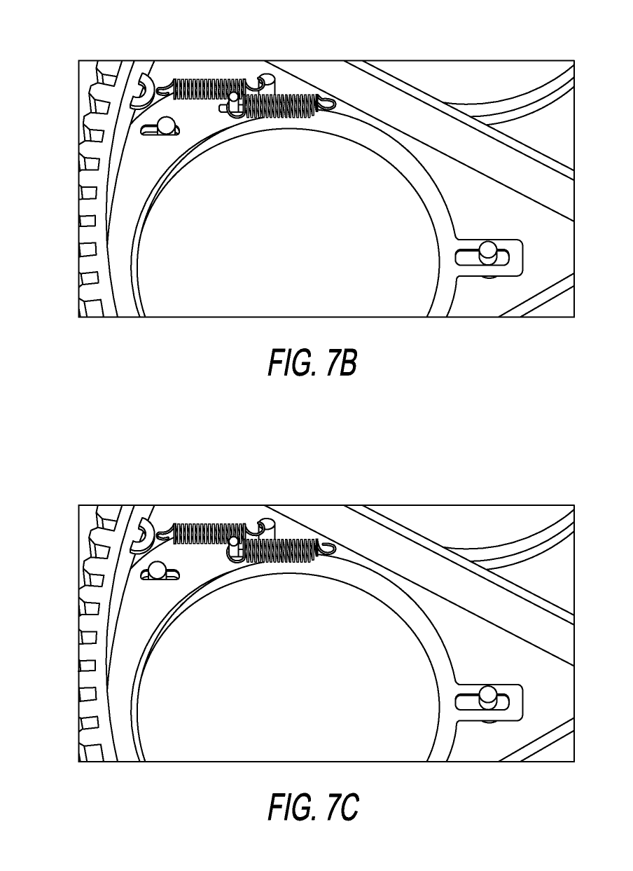

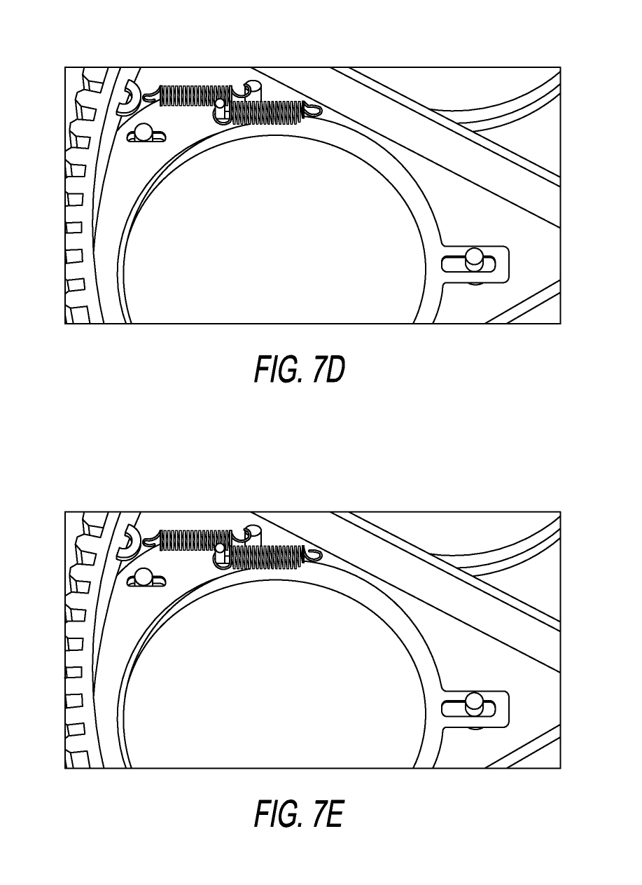

FIGS. 7a-e are a schematic representations of the actuation of a dual slide 5 singulation wedge mechanism according to yet another embodiment of the present disclosure. The double slider mechanism results in locking of the second from bottom cup while allowing the bottom cup to be pulled from the bottom of the stack. Alternative, the dual slider mechanism provides for a top slider that supports the entire cup stack minus the bottom most cup, i.e. it could be used without the aid of a linear slide actuator/gripper mechanism so as to allow consistent dispensing of a single cup manually.

While we have shown and described several embodiments in accordance with our invention, it is to be clearly understood that the same may be susceptible to numerous changes apparent to one skilled in the art. Therefore, we do not wish to be limited to the details shown and described but intend to show all changes and modifications that come within the scope of the appended claims.

1. A cup dispensing apparatus, comprising:
a cup holder for holding a plurality of the cups in stacked alignment, wherein said cup holder comprises a top surface, a bottom surface, and a plurality of holes therethrough;
a gripping mechanism for removing a single, bottommost one of the cups from the cup holder at a time, wherein said gripping mechanism is slidably connected to a linear actuator; and
a controller in communication with said cup holder and said gripping mechanism,
wherein said controller has a program resident thereon that controls said cup holder to present said plurality of cups to said gripping mechanism, and controls said gripping mechanism to grip said bottommost cup and remove it from said cup holder.

2. The apparatus of claim 1, further comprising a plurality of latches slidably connected to said top surface of said cup holder and in communication with said controller, wherein each of said latches is associated with one of said plurality of holes, and wherein said latch selectively restricts the size of the associated hole based upon input from the controller.

3. The apparatus of claim 1, wherein said cup holder is circular and comprises a plurality of wedge-shaped sections, each of said wedge-shaped sections comprising one of said plurality of holes.

4. The apparatus of claim 3, further comprising plurality of latches slidably connected to said top surface of said cup holder and in communication with said controller, wherein each of said latches is associated with one of said wedge-shaped sections and one of said plurality of holes, and wherein said latch selectively restricts the size of the associated hole based upon input from the controller.

5. The apparatus of claim 3, wherein said cup holder rotates along a horizontal axis to present said cup to said gripping mechanism, and said gripping mechanism moves along said actuator in a vertical direction.

6. The apparatus of claim 3, wherein at least two of said plurality of holes are differently sized, so as to accommodate differently-sized cups.

7. The apparatus of claim 1, further comprising a display in communication with said controller, through which a user may select a program to control said cup holder and said gripping mechanism.

8. A method of dispensing a cup from a cup holder, comprising:
presenting a plurality of cups to a gripping device, wherein said plurality of cups are arranged in a stacked vertical alignment;
controlling said gripping device to grip a bottommost one of said cups;
retaining the remainder of said plurality of stacked cups in place;
controlling said gripping device to remove said bottommost cup.

9. The method of claim 8, wherein said plurality of cups are presented to said gripping device with a circular cup holder that rotates along a horizontal axis, and wherein said cup holder has a plurality of holes therein for storing said plurality of cups.

10. The method of claim 9, further comprising controlling said gripping device to move along a linear actuator in a vertical direction before removing said bottommost cup.

11. The method of claim 10, wherein said retaining step is conducted with a latch slidingly connected to a top surface of said cupholer.
